(19) United States
(12) Patent Application Publication
(10) Pub. No.: US 2026/0151830 A1
(43) Pub. Date: Jun. 4, 2026

(54) ADDITIVE MANUFACTURING METHOD FOR MANUFACTURING A METAL PART COMPRISING INCLUSIONS OF AT LEAST ONE PHOSPHOR COMPOUND

(71) Applicant: COMMISSARIAT A L'ENERGIE ATOMIQUE ET AUX ENERGIES ALTERNATIVES, Paris (FR)

(72) Inventors: Christina BASLARI, Versailles (FR); Sonia DE SOUSA NOBRE CATTOEN, Saint Martin Le Vinoux (FR); Wilfried PACQUENTIN, Chaudon (FR); Hicham MASKROT, Montlhery (FR)

(73) Assignee: COMMISSARIAT A L'ENERGIE ATOMIQUE ET AUX ENERGIES ALTERNATIVES, Paris (FR)

(21) Appl. No.: 19/121,572

(22) PCT Filed: Oct. 20, 2023
(86) PCT No.: PCT/FR2023/051652

§ 371 Date: Apr. 16, 2025

(30) Foreign Application Priority Data
Oct. 21, 2022 (FR) FR2210958

(51) Int. Cl. B22F 10/28; B33Y 10/00; B33Y 70/10

(52) U.S. Cl. CPC B22F 10/28; B33Y 10/00; B33Y 70/10; B22F 2301/35; B22F 2302/25

(57) ABSTRACT

A method for manufacturing a metal alloy part by additive manufacturing, the metal alloy comprising a metal element A and the part further comprising inclusions of a phosphor compound consisting of a metal oxide doped by said metal element A. The method includes forming a layer comprising said metal alloy comprising a metal element A and inclusions of said phosphor compound by an additive manufacturing technique selected from laser metal deposition and laser powder bed fusion, from a mixture comprising a metal alloy powder comprising the metal element A and a precursor powder of said phosphor compound. The precursor powder consists of a powder of the metal oxide optionally doped with a metal element B different from the metal element A, said phosphor compound being formed in situ, during the implementation of the additive manufacturing technique, by atomic diffusion of a portion of the metal element A of the metal alloy to the metal oxide and exchange of the metal element A with a metal element of the metal oxide.

### TECHNICAL FIELD

The present invention relates to a manufacturing method by additive manufacturing of a metal alloy part, such as a steel part, comprising at least one phosphor compound. The present invention naturally applies to all types of industries desiring to design metal parts having optical properties by incorporating phosphor compound(s) into said parts.

Conventionally, the metal alloy parts comprising additives are prepared by a mechanical and very energy-intensive co-grinding step (for example, via a ball mill or an attritor) of a powder of a metal alloy intended to enter into the composition of the part and of a powder of the phosphor compound, said co-grinding step being followed by a step of sintering the mixture of the powders to form the desired metal part. The manufacturing of metal alloy parts in this way does not make it possible to easily obtain parts with too complex shapes, due to the difficulty of obtaining molds suitable for this type of shapes.

Thus, in view of what already exists, the authors of the present invention proposed to develop a method for manufacturing a metal alloy part taking advantage of a specific additive manufacturing technique and of the advantages resulting therefrom, such as the operating conditions for making it possible to form the phosphor compound(s) included in said part and a greater variety of shapes that can be achieved, which makes it possible to extend the field of application in all fields requiring the use of metal parts with phosphor properties.

### DISCLOSURE OF THE INVENTION

Thus, the invention relates to a method for manufacturing a metal alloy part by additive manufacturing, said metal alloy comprising a metal element A and said part further comprising inclusions of a phosphor compound consisting of a metal oxide doped with said metal element A, said method comprising at least one step of forming a layer comprising said metal alloy comprising a metal element A and inclusions of said phosphor compound by an additive manufacturing technique selected from laser metal deposition and laser powder bed fusion, from a mixture comprising a metal alloy powder comprising the metal element A and a precursor powder of said phosphor compound, said precursor powder consisting of a powder of said metal oxide optionally doped with a metal element B different from said metal element A, said phosphor compound being formed in situ, during the implementation of the additive manufacturing technique, by atomic diffusion of a portion of the metal element A of the metal alloy to the metal oxide and exchange of said metal element A with a metal element of the metal oxide.

The metal alloy of the metal alloy powder may be selected from iron alloys, aluminum alloys, titanium alloys, nickel alloys, copper alloys, and steels.

The metal element A present in the metal alloy powder may be selected from In, Sn, Pb, Sb, Bi, Ce, Pr, Nd, Sm, Eu, Gd, Tb, Dy, Ho, Er, Tm, Yb, Ti, V, Cr, Mn, Fe, Co, Ni, Cu, Ru, Pd, Ag, Ir, Pt and Au.

In an advantageous variant, this metal element A is selected from Cr, Ce, Fe and Mn.

In a preferred variant, this metal element A is Cr.

In a particular embodiment, the steels are stainless steels, that is to say steels comprising chromium as metal element A. More specifically, the metal alloy may be steel comprising, in addition to chromium, one or more elements selected from manganese, phosphorus, sulfur, silicon, nickel, molybdenum, cobalt and mixtures thereof.

More particularly, the metal alloy of the metal part may be austenitic steel, for example, an austenitic steel of the grade 1.4404, 304L or 316L.

The phosphor compound consisting of a metal oxide doped with said metal element A may be a metal oxide doped with chromium (in which case the metal element A corresponds to chromium), it being understood that this metal oxide thus doped must have phosphor properties, that is to say an ability to emit light after excitation.

The metal oxide of the precursor powder of the phosphor compound may be an oxide of one or more metals selected from Li, K, Mg, Ca, Sr, Ba, Sc, Y, La, Lu, Ti, Zr, Hf, V, Nb, Ta, Zn, Cd, B, Al, Ga, Si and Ge.

This metal oxide may be a simple metal oxide and be advantageously selected from Li₂O, K₂O, MgO, CaO, SrO, BaO, Sc₂O₃, Y₂O₃, La₂O₃, Lu₂O₃, TiO₂, ZrO₂, HfO₂, V₂O₅, Nb₂O₅, Ta₂O₅, ZnO, CdO, B₂O₃, Al₂O₃, Ga₂O₃, SiO₂ and GeO₂.

This metal oxide may also be a mixed metal oxide and be advantageously selected from Y₃Al₅O₁₂, YAlO₃, Y₄Al₂O₉, Sr₄Al₂O₇, Sr₃Al₂O₆, SrAl₂O₄, SrAl₄O₇, Sr₄Al₁₂O₁₉, SrAl₁₂O₁₉, LiAlO₂, LaAlO₃, MgGa₂O₄, CaAl₂O₄, ZnAl₂O₄, CaGa₂O₄, CaGa₄O, BaAl₂O₄, CaAl₄O₇, LiAl₅O₈, KAl₁₁O₁₇, KGa₁₁O₁₇, BaMgAl₁₀O₁₇ and Ca_{0.5}Ba_{0.5}Al₁₂O₁₉.

This mixed metal oxide may more particularly be selected from garnets, spinels and perovskites.

When this mixed metal oxide is a garnet, it meets the general chemical formula X₃Z₅O₁₂ and may particularly be Y₃Al₅O₁₂.

When this mixed metal oxide is a spinel, it meets the general chemical formula XZ₂O₄ and may particularly be SrAl₂O₄, BaAl₂O₄, MgGa₂O₄, CaAl₂O₄, CaGa₂O₄ or even ZnAl₂O₄.

When this mixed metal oxide is a perovskite, it meets the general chemical formula XZO₃ and may in particular be YAlO₃ or even LaAlO₃.

In a preferred variant, the mixed metal oxide of the precursor powder of the phosphor compound is selected from Y₃Al₅O₁₂, BaAl₂O₄, SrAl₂O₄ and YAlO₃.

In an even more preferred variant, this mixed metal oxide of the precursor powder of the phosphor compound is the garnet-type oxide meeting formula Y₃Al₅O₁₂.

As indicated above, the metal oxide of the precursor powder of the phosphor compound may optionally be doped with a metal element B, it being specified that this metal element B is then different from the metal element A present in the metal alloy powder.

This metal element B may in particular be selected from In, Sn, Pb, Sb, Bi, Ce, Pr, Nd, Sm, Eu, Gd, Tb, Dy, Ho, Er, Tm, Yb, Ti, V, Cr, Mn, Fe, Co, Ni, Cu, Ru, Pd, Ag, Ir, Pt and Au.

In an advantageous variant, this metal element B is selected from Cr, Ce, Fe and Mn.

In particular, when the metal element A is not Cr, the metal element B is advantageously Cr.

In a preferred variant, and particularly (but not only) when the metal element A is Cr, the metal element B is Ce.

By way of examples of phosphor compounds that may be formed in situ when implementing the additive manufacturing technique, mention may be made in particular of: Y₃Al₅O₁₂:Ce³⁺, YAlO₃:Ce³⁺, Y₃Al₅O₁₂:Eu³⁺, YAlO₃:Eu³⁺, Y₄Al₂O₉:Eu³⁺, YAlO₃:Sm³⁺, YAlO₃:Tb³⁺, Al₂O₃:Cr³⁺, Y₂O₃:Eu³⁺, LiAlO₂:Fe³⁺, LiAlO₂:Mn²⁺, LaAlO₃:Eu³⁺, LaAlO₃:Sm³⁺, MgAl₂O₄:Mn²⁺, MgGa₂O₄:Mn²⁺, CaAl₂O₄:Mn²⁺, CaAl₂O₄:Eu²⁺, ZnAl₂O₄:Mn²⁺, ZnGa₂O₄:Mn²⁺, CaGa₂O₄:Mn²⁺, CaGa₄O:Mn²⁺, SrAl₂O₄:Eu²⁺, BaAl₂O₄:Eu²⁺, CaAl₄O₇:Pb²⁺,Mn²⁺, LiAl₅O₈:Fe³⁺, LiAl₅O₈:Mn²⁺, KAl₁₁O₁₇:Ti⁺, KGa₁₁O₁₇:Mn²⁺, BaMgAl₁₀O₁₇:Ce³⁺, BaMgAl₁₀O₁₇:Eu²⁺, BaMgAl₁₀O₁₇:Eu²⁺,Mn₂₊, Ca_{0.5}Ba_{0.5}Al₁₂O₁₉:Ce³⁺,Mn²⁺, SrAl₁₂O₁₉:Eu²⁺,Mn²⁺, SrGa₁₂O₁₉:Mn²⁺, SrAl₁₂O₁₉:Ce³⁺,Mn²⁺ and Y₃Al₅O₁₂:Ce³⁺,Cr³⁺.

The phosphor compound may thus be a garnet-type oxide meeting the formula Y₃Al₅O₁₂ (also known by the acronym YAG) doped with chromium (referred to as YAG:Cr³⁺), which means in other words that a part of the aluminum of the YAG is substituted with chromium, said oxide being able to be doped, in addition, with another metal element B, such as cerium. Thus, more specifically, the phosphor compound may be a garnet-type oxide meeting the formula Y₃Al₅O₁₂ doped with cerium and with chromium (named Y₃Al₅O₁₂:Ce³⁺,Cr³⁺), with cerium being in substitution on the dodecahedral sites of the yttrium and chromium being in substitution on the octahedral sites of the aluminum. The YAG compound doped with both chromium Cr³⁺ and cerium Ce³⁺ has a luminescence both in red (i.e. between 650 nm and 750 nm) due to in situ doping of Cr³⁺ and a luminescence in green/yellow (i.e. between 500 nm and 575 nm) due to Ce³⁺ initially present in the YAG crystal.

Alternatively, the phosphor compound may be a spinel-type oxide doped with chromium.

Furthermore, the method may comprise at least one step of forming a layer consisting of said metal alloy comprising a metal element A by an additive manufacturing technique selected from laser metal deposition and laser powder bed fusion from a powder consisting of a metal alloy powder comprising the metal element A.

Thus, the method covers the manufacturing of the following parts:
a part of which each layer formed by the method is a layer comprising said metal alloy comprising a metal element A and inclusions of said phosphor compound, in which case there will be no implementation of the formation step mentioned just above;
otherwise, that is to say, in the case where the formation step mentioned just above will be implemented one or more times, a part of which at least one of the layers formed by the method is a layer comprising said metal alloy comprising a metal element A and inclusions of said phosphor compound and at least one of the layers formed by the method is a layer consisting of said metal alloy comprising a metal element A and this irrespective of how these layers are arranged with respect to one another.

Whether for one or the other of the above-mentioned formation steps, these are implemented by a specific additive manufacturing technique selected from laser metal deposition and laser powder bed fusion.

In particular, according to a first embodiment, each step of forming a layer comprising said metal alloy comprising a metal element A and inclusions of said phosphor compound and, if applicable, each step of a layer consisting of said metal alloy comprising a metal element A may be implemented by a laser metal deposition method, also known as the following: direct laser manufacturing method or, more precisely, direct laser metal deposition manufacturing method or Laser Metal Deposition (LMD) method or Directed Energy Deposition (DED) method. Generally, the laser metal deposition method is based on the combined use of a power laser and a coaxial or side injection powder dispensing device (conventionally, a nozzle). From a practical point of view, for each layer to be deposited, the powder or the powder mixture, carried by a carrier gas (for example, argon, helium, nitrogen) is melted, in whole or in part, in contact with the laser beam, the fusion being able to be completed in contact with the metal liquid bath formed on the substrate (or manufacturing plate) resulting from the laser-material interaction, before solidification of the whole (melted powder+metal liquid bath resulting from the melting of the lower layers). The movement of the laser, the powder dispensing device and the substrate are controlled in relation to a numerical model defined in the formation of the part to be obtained.

The laser metal deposition method depends on several parameters including the features of the powder or powder mixture, the nature and power of the laser, the laser scanning speed, the powder flow rate, the desired layer thickness and the distance between each manufacturing bead. The person skilled in the art will determine, if necessary, by preliminary tests, these various parameters, depending on the metal part that he wishes to obtain.

In particular, when the phosphor compound is a compound of the YAG type doped with cerium and with chromium and the sprayed powder mixture comprises a 316L steel powder and a YAG powder doped with cerium, the parameters of the step(s) of forming the layer comprising 316L steel and inclusions of YAG doped with cerium and with chromium may be as follows:
for an OPTOMEC machine, a fiber laser doped with ytterbium, a wavelength of 1,064 nm and a laser spot of 1.2 mm for a working distance fixed at 12 mm;
a laser power from 300 W to 1,000 W;
a scanning speed from 1 mm/s to 100 mm/s;
a powder flow rate from 0.5 rpm to 20 rpm (rpm corresponding to the rotational speed of the powder dispensing motor);
an inter-bead distance from 0.1 mm to 2 mm and a layer thickness of 0.1 mm to 2 mm.

More specifically, when the phosphor compound is a compound of the YAG type doped with cerium and with chromium and the precursor powder of said compound is a powder of a compound of the YAG type doped with cerium, the laser fluence, during the formation step, advantageously ranges from 265 W/mm² to 900W/mm².

In particular, when the sprayed powder is a 316L steel powder, the parameters of the step(s) of forming the layer consisting of 316L steel are as follows:
a spherical powder morphology with a particle size advantageously ranging from 45 μm to 106 μm;
for an OPTOMEC machine, a fiber laser doped with ytterbium, a wavelength of 1,064 nm and a laser spot of 1.2 mm for a working distance of 12 mm between the laser projection nozzle and the substrate;
a laser power from 100 W to 1,500 W;
a scanning speed from 1 mm/s to 100 mm/s;
a powder flow rate from 0.5 rpm to 20 rpm (rpm corresponding to the rotational speed of the powder dispensing motor);
an inter-bead distance from 0.1 mm to 2 mm and a layer thickness of 0.1 mm to 2 mm.

For each step of forming a layer comprising said metal alloy comprising a metal element A and inclusions of said phosphor compound, the metal alloy powder and the precursor powder of said phosphor compound may be dispensed via a single powder dispenser (in which case, the two powders form a mixture in the dispenser) or may be dispensed simultaneously via two separate powder dispensers.

In the case where the metal alloy powder and the precursor powder of said phosphor compound are distributed simultaneously via two separate powder dispensers (it being understood that the two types of powders must have good flowability), the metal alloy powder and the precursor powder of said phosphor compound will advantageously have a spherical morphology with a grain size from 45 μm to 106 μm. With the use of two separate powder dispensers, there is a possibility to independently adjust the metal alloy powder flow rate and the precursor powder flow rate depending on the desired percentage of phosphor compound insertions. For example, to obtain a phosphor compound incorporation of up to 6.25% during the manufacturing of the layer concerned, the metal alloy powder flow rate may be fixed at 3.75 rpm and the precursor powder flow rate may be fixed at 0.75 rpm.

According to a second embodiment, each step of forming a layer comprising said metal alloy comprising a metal element A and inclusions of said phosphor compound and, if applicable, each step of forming a layer consisting of said metal alloy comprising a metal element A may be implemented by a Laser Powder Bed Fusion (LPBF) method or Selective Laser Melting (SLM) method or Laser Beam Melting (LBM) method. Generally, the LPBF method consists in spreading powder on a manufacturing plate then passing a laser over the powder thus spread to melt said powder, the molten material subsequently solidifying by cooling, this sequence of steps being repeated as many times as necessary until the desired part is obtained. The trajectory of the laser is defined by a digital file (CAD file then slicer that cuts the part into layers).

The laser powder bed fusion method depends on several parameters including the features of the powder, the nature and power of the laser, the laser scanning speed, the layer thickness, and the distance between each manufacturing bead. The person skilled in the art will determine, if necessary, by prior tests, these various parameters, depending on the metal part that he wishes to obtain.

In particular, when the phosphor compound is a compound of the YAG type doped with cerium and with chromium and the mixture comprises a 316L steel powder and a YAG powder doped with cerium, the parameters of the layer formation step(s) comprising 316L steel and inclusions of YAG doped with cerium and with chromium may be as follows:
for a TruPrint 1000 machine, a fiber laser doped with ytterbium, a wavelength of 1,064 nm and a laser spot of 55 μm;
a laser power from 20 W to 200 W;
a scanning speed from 10 mm/s to 1,300 mm/s;
a layer thickness from 10 μm to 100 μm;
an inter-bead distance from 10 μm to 150 μm.

More specifically, when the phosphor compound is a compound of the YAG type doped with cerium and with chromium and the precursor powder of said compound is a powder of a compound of the YAG type doped with cerium, the laser fluence, during each step of formation, advantageously ranges from 8,400 W/mm² to 84,000W/mm².

In particular, when the powder is a 316L steel powder, the parameters of the step(s) of forming the layer consisting of 316L steel are as follows:
for a TruPrint 1000 machine, a fiber laser doped with ytterbium, a wavelength of 1,064 nm and a laser spot of 55 μm;
a laser power from 20 W to 500 W;
a scanning speed from 10 mm/s to 3,000 mm/s;
a layer thickness from 10 μm to 100 μm;
an inter-bead distance from 10 μm to 150 μm.

The powders for the LPBF method must advantageously have a spherical morphology and a particle size from 15 μm to 45 μm.

In both the laser metal deposition and laser powder bed fusion techniques, the authors of the present invention were able to demonstrate the in situ formation of the phosphor compound concurrently with the implementation of the selected technique, the energy engaged during this implementation allowing the atomic diffusion of said metal element A in the metal oxide and the exchange of said metal element A with a metal element of the metal oxide, this process may be demonstrated by laser spectroscopy tests and by analyzing the luminescent emission bands of the phosphor compound obtained.

When the phosphor compound is a garnet-type compound of formula Y₃Al₅O₁₂ doped with chromium and with cerium, the precursor powder of said phosphor compound may be a powder of garnet-type compound of formula Y₃Al₅O₁₂ doped with cerium.

Before implementing the above-mentioned formation steps and when the technique implemented is the LPBF technique or, failing that, when the technique implemented is the laser metal deposition technique and one of the powders does not have good flowability, the method may comprise a preliminary step of preparing the mixture comprising the powder of said metal alloy and a precursor powder of said phosphor compound. This preliminary mixing step is advantageously adapted when at least one of the powders does not have a morphology adapted to good flowability (for example, a powder having a spherical morphology with a particle size from 45 μm to 106 μm in the case where the technique selected is laser metal deposition). This preparation step may consist in bringing said metal alloy powder and said precursor powder into contact and subjecting the resulting mixture to all mixing techniques particularly making it possible to improve the flowability thereof. In particular, contact may be carried out in a rotary mixer or in a container subjected to agitation by attachment to a stirrer.

In the latter case, deagglomeration objects, such as beads, may be added to the container.

In particular, these deagglomeration objects, such as beads, have sufficient strength and do not induce pollution of the powder mixture. They may be, in particular, ceramic balls or metal balls and, more specifically, steel balls.

The balls may have a diameter from 5 mm to 15 mm, preferably from 3 mm to 7 mm and, even more specifically, balls having a diameter of about 5 mm.

The volume ratio between the deagglomeration objects, such as beads, and powders (atomized powder+oxide powders) may range from 0.5 to 3.

The tank, wherein the powders and the powder deagglomeration objects are placed, may be a tank made of plastic or metal material, it being understood that the material must be strong enough to withstand the shocks induced by the mixing operation. The tank may be a tank with a volume of 1 to 2 liters.

Advantageously, the tank has a filling rate from 30 to 70% (for example, equal to 40%), this filling rate corresponding to the % of the total volume of the tank occupied by the powders and the powder deagglomeration objects.

The tank is attached to a stirrer which will impart a stirring movement to the tank, this stirrer may particularly be a three-dimensional stirrer, such as those marketed under the Turbula® brand. In such a stirrer, the reservoir is subjected to a three-dimensional movement due to the action of the stirrer and the content of the tank (i.e. the powders and the powder deagglomeration objects) is thus subjected to a continuously changing pulsed movement.

Finally, regardless of the additive manufacturing technique retained, the layer forming steps are repeated as many times as possible until the desired part with a selected thickness and shape is obtained.

Other advantages and features of the invention will become apparent in the following non-limiting detailed description.

### BRIEF DESCRIPTION OF THE DRAWINGS

FIG. 1 shows a photograph of a section of the sample with insertion of the phosphor compound obtained according to Example 1, the dark particles corresponding to the luminescent particles, the enlarged views above the photograph corresponding to the various spots for the laser spectroscopy tests.

FIG. 2 is a graph illustrating the evolution of the intensity I (in arbitrary units u.a.) as a function of the wavelength λ (in nm), curve a) corresponding to Spot 1 of the sample of FIG. 1, curve b) to Spot 2 of the sample of FIG. 1, curve c) to Spot 3 of the sample of FIG. 1 and curve d) to Spot 4 of the sample of FIG. 1.

FIG. 3 shows a photograph of a section of the sample with insertion of the phosphor compound obtained according to Example 2.

FIG. 4 shows a graph illustrating the evolution of the intensity I (in arbitrary units u.a.) as a function of the wavelength λ (in nm), curve a) corresponding to Spot 2 of the sample of FIG. 3, curve b) to Spot 4 of the sample of FIG. 3, curve c) to Spot 5 of the sample of FIG. 3, curve d) to Spot 6 of the sample of FIG. 3, curve e) to Spot 7 of the sample of FIG. 3, curve f) to Spot 9 of the sample of FIG. 3, curve g) to Spot 10 of the sample of FIG. 3, curve h) to Spot 15 of the sample of FIG. 3, curve i) to Spot 18 of the sample of FIG. 3 and curve j) to Spot 20 of the sample of FIG. 3.

### DETAILED DESCRIPTION OF PARTICULAR EMBODIMENTS

### Example 1

This example illustrates the implementation of the method in accordance with the invention for the manufacturing by LMD of a part made of austenitic steel of grade 316L comprising inclusions of a phosphor compound of the YAG type doped with cerium and with chromium.

Before manufacturing the part as such, a powder mixture comprising the powder consisting exclusively of austenitic steel 316L and a precursor powder of the phosphor compound is first prepared, this precursor powder consisting exclusively of a compound of the YAG type doped with cerium Ce³⁺. To do this, the powder of austenitic steel 316L has a grain size from 45 μm to 106 μm, an apparent density of 4.02 g/cm³, a tap density of 4.77 g/cm³ and a flowability of 17.70 s/50 g (determined with a Hall cone) and the precursor powder of the phosphor compound has a particle size from 6.6 μm to 37.3 μm at a rate of 5% by mass relative to the total mass of the mixture are mixed by mechanosynthesis for 15 hours at a rotational speed of 400 revolutions/minute.

Then, firstly, the deposition of 8 layers is carried out from a powder consisting exclusively of austenitic 316L steel, each layer being deposited by means of an OPTOMEC laser projection machine with a fiber infrared laser and doped with ytterbium having a wavelength of 1,064 nm and a spot of 1.2 mm, the other parameters used being the following:
Working distance: 12 mm;
Laser power: 450 W;
Scanning speed: 5 mm/s;
Powder flow: 2 rpm;
Inter-bead distance: 0.84 mm and layer thickness: 0.5 mm.

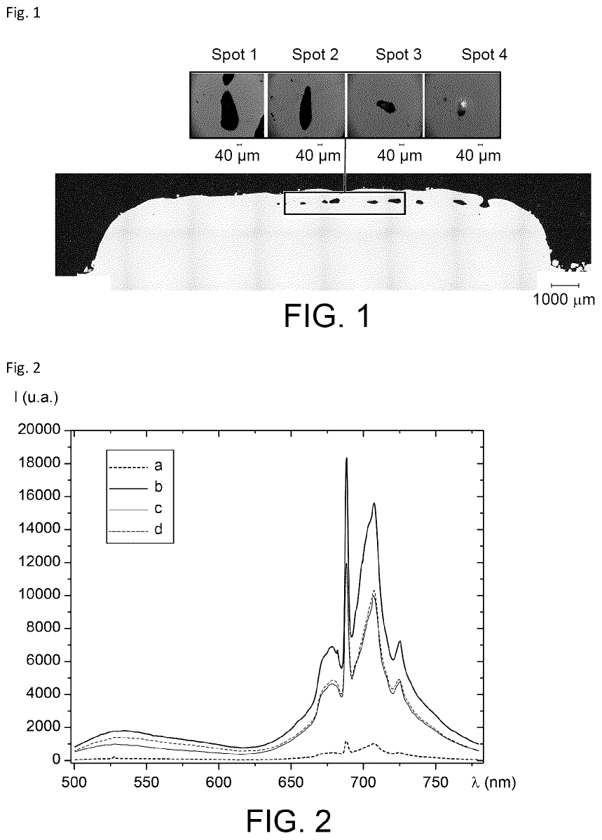

Secondly, the mixture thus obtained is also deposited by LMD on the layers previously deposited by LMD, in the form of two layers, according to a laser creep of 398 W/mm² (laser power delivered per cm²), whereby the phosphor compound is inserted on the last manufacturing layers of the metal compound, as illustrated in FIG. 1 representing a photograph of a section of the sample with insertion of the phosphor compound, the dark particles corresponding to luminescent particles.

Laser spectroscopy tests for an excitation wavelength of 405 nm were carried out at various spots (indicated in FIG. 1, Spot 1, Spot 2, Spot 3 and Spot 4), the results being reported in FIG. 2, illustrating the evolution of the intensity I (in arbitrary units u.a.) as a function of the wavelength λ (in nm), curve a) corresponding to Spot 1 of the sample of FIG. 1, curve b) to Spot 2 of the sample of FIG. 1, curve c) to Spot 3 of the sample in FIG. 1 and curve d) to Spot 4 of the sample in FIG. 1. The result is that, for the sample, the emission of cerium is still present, which is characterized by a wide emission band between 500 and 575 nm but also a new band appears with peaks staggering from 650 nm to 750 nm corresponding to a new phase corresponding to Y₃Al₅O₁₂:Cr or, in other words, to the YAG compound doped with chromium. Given that the simultaneous emission of Ce³⁺ ions and Cr³⁺ ions is observed, this proves that the phosphor compound is a YAG compound doped both with cerium (which remains from the original doping) and with chromium (which results from the in situ atomic diffusion of the chromium from the metal alloy to the YAG compound during deposition by LMD thanks to the high temperatures involved during this deposition). Without being bound by theory, the chromium present in 316L steel diffuses to the YAG:Ce precursor compound and takes the place of a portion of the aluminum on the octahedral sites of the YAG crystallographic structure, the incorporation of chromium inducing emission peaks in the red region (i.e. between 650 nm and 750 nm).

The phosphor compound particles have an average size of 200 μm, which corresponds to a size greater than the size of the precursor powder, which could be explained by a coalescence phenomenon during the fusion of the powder followed by solidification.

Alternatively, a metal part was prepared on the basis of the same conditions as those mentioned above, except that the preparation of the mixture was obtained by means of a three-dimensional stirrer of the Turbula type.

For this purpose, the 316L steel powder (237.5 g) and the YAG: Ce powder (12.5 g) at a ratio of 2% by mass relative to the total mass of the powder mixture are placed in the same plastic vial (of the VWR brand, translucent LD-PE, 1L) in the presence of steel beads (1,010 g) of 5 mm diameter, the filling rate of the vial being 40%.

The vial is closed and then attached to a stirrer of the Turbula® brand, the model being similar to the Turbula® type T2F, with dimensions of 500*600*400 mm, a maximum load of the container from 6 to 10 kg and a movement frequency from 23 to 101 min⁻¹ and stirring is practiced for a duration of 18 hours, the container being attached to a nacelle by elastics then pulsed three-dimensional movements are applied thereto during this duration.

Once mixing is complete, the content of the vial is recovered and the powder and beads are separated using a simple sieve.

The metal part thus obtained is also subjected to laser spectroscopy tests for an excitation wavelength of 405 nm, which also make it possible to detect the chromium-doped YAG phase, which demonstrates that the mixing technique for preparing the powder mixture has no influence on obtaining the phosphor compound. Moreover, it appears that the chromium-doped YAG phase appears with the powder mixture with 2% of YAG: Ce powder as with the powder mixture with 5% of YAG:Ce powder, which shows that the amount of YAG:Ce powder in the mixture has no influence on obtaining this phase.

### Example 2

This example illustrates the implementation of the method in accordance with the invention for manufacturing a part made of austenitic steel of grade 316L comprising inclusions of a phosphor compound of the YAG type doped with cerium and with chromium.

Before manufacturing the part as such, a powder mixture comprising the powder consisting exclusively of austenitic steel 316L and a precursor powder of the phosphor compound is first prepared, this precursor powder consisting exclusively of a compound of the YAG type doped with cerium Ce³⁺. To do this, a powder of austenitic steel 316L (154 g) meeting the same features as those defined below and a precursor powder of the phosphor compound, in this case YAG doped with cerium (8 g) having a particle size from 6.6 μm to 37.3 μm are placed in a vial. The vial is subsequently closed and attached to a Turbula® stirrer, the model being similar to the Turbula® type T2F with dimensions of 500*600*400 mm, a maximum vial load from 6 to 10 kg and a movement frequency from 23 to 101min⁻¹. The vial is attached to a nacelle by elastics, then pulsed three-dimensional movements are applied thereto for 18 hours.

Then, firstly, a deposition of 434 layers consisting of austenitic steel 316L is carried out from a powder having a grain size from 15 μm to 45 μm, an apparent density of 4.42 g/cm², a flowability of 13 s/50 g (determined by means of a Hall cone), each layer being deposited by a laser powder bed fusion method (LPBF technique) with a fiber-infrared laser doped with ytterbium having a wavelength of 1,064 nm and a spot of 55 μm, the other parameters used being the following:
Laser power: 165 W;
Scanning speed: 950 mm/s;
Inter-bead distance: 50 μm and layer thickness: 30 μm.

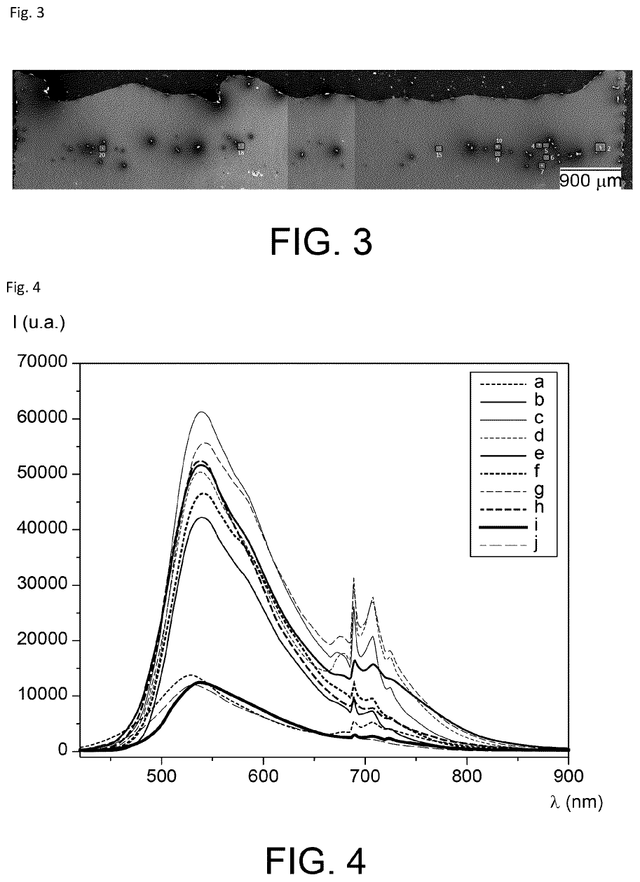

Secondly, the deposition of 33 layers is carried out, from the aforementioned mixture, each layer being deposited by a laser powder bed fusion method (LPBF technique) with a fiber infrared laser doped with ytterbium having a wavelength of 1,064 nm and a spot of 55 μm, the other parameters used being the following:
Laser power: 80 W;
Scanning speed: 350 mm/s;
Inter-bead distance: 50 μm and layer thickness: 30 pm.
   whereby the phosphor compound is inserted, according to a thickness of 1 mm, on the last manufacturing layers of the metal compound, as illustrated in FIG. 3 showing a photograph of a section of the sample with insertion of the phosphor compound, the dark particles corresponding to the luminescent particles.

Laser spectroscopy tests for an excitation wavelength of 405 nm were carried out at various spots (indicated in FIG. 3, by squares numbered 2, 4, 5, 6, 7, 9, 10, 15, 18 and 20, respectively), the results being reported in FIG. 4, illustrating the evolution of the intensity I (in arbitrary units u.a.) as a function of the wavelength λ (in nm), curve a) corresponding to Spot 2 of the sample of FIG. 3, curve b) to Spot 4 of the sample of FIG. 3, curve c) to Spot 5 of the sample of FIG. 3, curve d) to Spot 6 of the sample of FIG. 3, curve e) to Spot 7 of the sample of FIG. 3, curve f) to Spot 9 of the sample of FIG. 3, curve g) to Spot 10 of the sample of FIG. 3, curve h) to Spot 15 of the sample of FIG. 3, curve i) to Spot 18 of the sample of FIG. 3 and curve j) to Spot 20 of the sample of FIG. 3.

The spectrum illustrates a broad band with a peak around 540 nm, which corresponds to the emission due to cerium. Compared to the initial emission before manufacturing (peaks around 570 nm), the band of cerium after manufacturing is characterized by a shift to the left which is explained by the fact that the crystalline environment around the Ce ion after manufacturing has changed (presence of Cr and potentially of other elements of the 316L steel in the YAG matrix) and therefore leads to a shift to shorter wavelengths. Subsequently, the area from 650 to 750 nm corresponds to the emission of chromium. In particular, the peak at 688 nm is the characteristic peak of the R-lines of the doped Cr in the YAG matrix.

It is also noted that not all particles have the same intensity. The intensity depends on the crystallinity of the particle, on the defects present in the luminescent matrix and on the energy transfer between cerium and chromium.

1. A method for manufacturing a metal alloy part by additive manufacturing, said metal alloy comprising a metal element A and said part further comprising inclusions of a phosphor compound consisting of a metal oxide doped with said metal element A, said method comprising:
forming a layer comprising said metal alloy comprising a metal element A and inclusions of said phosphor compound by an additive manufacturing technique selected from laser metal deposition and laser powder bed fusion, from a mixture comprising a metal alloy powder comprising the metal element A and a precursor powder of said phosphor compound,
said precursor powder consisting of a powder of said metal oxide doped with a metal element B different from said metal element A,
said phosphor compound being formed in situ, during the implementation of the additive manufacturing technique, by atomic diffusion of a portion of the metal element A of the metal alloy to the metal oxide and exchange of said metal element A with a metal element of the metal oxide.

2. The method according to claim 1, further comprising forming a layer consisting of said metal alloy comprising a metal element A by an additive manufacturing technique selected from laser metal deposition and laser powder bed fusion from a powder consisting of a metal alloy powder comprising the metal element A.

3. The method according to claim 1, wherein the metal alloy of the metal alloy powder is selected from iron alloys, aluminum alloys, titanium alloys, nickel alloys, copper alloys, and stainless steels.

4. The method according to claim 3, wherein, when the metal alloy is a steel, the steel is an austenitic steel selected from 316L steel, 304L steel, and 1.4404 steel.

5. The method according to claim 1, wherein the metal element A is selected from In, Sn, Pb, Sb, Bi, Ce, Pr, Nd, Sm, Eu, Gd, Tb, Dy, Ho, Er, Tm, Yb, Ti, V, Cr, Mn, Fe, Co, Ni, Cu, Ru, Pd, Ag, Ir, Pt, and Au.

6. The method according to claim 1, wherein the metal alloy is steel comprising, as metal element A, chromium.

7. The method according to claim 6, wherein the metal alloy comprises, in addition to chromium, one or more elements selected from manganese, phosphorus, sulfur, silicon, nickel, molybdenum, cobalt, and mixtures thereof.

8. The method according to claim 1, wherein the precursor powder consists of a powder of said metal oxide doped with a metal element B different from the metal element A, the metal element B being selected from In, Sn, Pb, Sb, Bi, Ce, Pr, Nd, Sm, Eu, Gd, Tb, Dy, Ho, Er, Tm, Yb, Ti, V, Cr, Mn, Fe, Co, Ni, Cu, Ru, Pd, Ag, Ir, Pt and Au.

9. The method according to claim 1, wherein the metal oxide of the precursor powder of the phosphor compound is an oxide of one or more metals selected from Li, K, Mg, Ca, Sr, Ba, Sc, Y, La, Lu, Ti, Zr, Hf, V, Nb, Ta, Zn, Cd, B, Al, Ga, Si, and Ge.

10. The method according to claim 9, wherein the metal oxide of the precursor powder of the phosphor compound is selected from Li₂O, K₂O, MgO, CaO, SrO, BaO, Sc₂O₃, Y₂O₃, La₂O₃, Lu₂O₃, TiO₂, ZrO₂, HfO₂, V₂O₅, Nb₂O₅, Ta₂O₅, ZnO, CdO, B₂O₃, Al₂O₃, Ga₂O₃, SiO₂, GeO₂, Y₃Al₅O₁₂, YAIO₃, Y₄Al₂O₉, Sr₄Al₂O₇, Sr₃Al₂O₆, SrAl₂O₄, SrAl₄O₇, Sr₄Al₁₂O₁₉, SrAl₁₂O₁₉, LiAIO₂, LaAlO₃, MgGa₂O₄, CaAl₂O₄, ZnAl₂O₄, CaGa₂O₄, CaGa₄O, BaAl₂O₄, CaAl₄O₇, LiAI₅O₈, KAI₁₁O₁₇, KGa₁₁O₁₇, BaMgAl₁₀O₁₇ and Ca_{0.5}Ba_{0.5}Al₁₂O₁₉.

11. The method according to claim 10, wherein the phosphor compound, when the metal element A is chromium, is a garnet-type oxide meeting the formula Y₃Al₅O₁₂ doped with chromium.

12. The method according to claim 10, wherein the phosphor compound, when the metal element A is chromium, is a garnet-type oxide meeting the formula Y₃Al₅O₁₂ doped with cerium and with chromium.

13. The method according to claim 12, wherein, when the phosphor compound is a garnet-type compound of formula Y₃Al₅O₁₂ doped with chromium and with cerium, the precursor powder of said phosphor compound is a powder of garnet-type compound of formula Y₃Al₅O₁₂ doped with cerium.
